(19) United States
(12) Patent Application Publication
(10) Pub. No.: US 2026/0293836 A1
(43) Pub. Date: Oct. 1, 2026

(54) COLLAPSIBLE AND PORTABLE PET PEE PAD CONTAINMENT SYSTEM

(71) Applicant: Amy Kim, Los Angeles, CA (US)

(72) Inventor: Amy Kim, Los Angeles, CA (US)

(21) Appl. No.: 19/633,616

(22) Filed: Mar. 30, 2026

Related U.S. Application Data
(60) Provisional application No. 63/780,012, filed on Mar. 28, 2025.

(51) Int. Cl. A01K 1/01

(52) U.S. Cl. CPC A01K 1/0107

(57) ABSTRACT

A pet peed pad containment system is movable between an operational orientation and a storage orientation. The system includes a first section including a first planar base configuring for providing a support surface for the pee pad in the operational orientation and first alignment sections extending upward from the first planar base in the operational orientation. The system also includes a second section pivotably connected to the first section enabling the pet peed pad containment system to be pivoted between the operational orientation and the storage orientation. The second section includes a second planar base configuring for providing a support surface for the pee pad in the operational orientation and second alignment sections extending upward from the second planar base in the operational orientation. The system also includes a seal configured for covering a seam between the first planar base and the second planar base in the operational orientation to prevent pee from leaking through the seam in the receiving area.

The present disclosure relates generally to holders for dog pee pads.

### BACKGROUND

Existing pee pad holders leak and are not easily transportable.

### SUMMARY

A pet peed pad containment system is provided that is movable between an operational orientation and a storage orientation. The operational orientation enables use by a pet to pee on a pee pad held within the pet peed pad containment system. The system includes a first section including a first planar base configuring for providing a support surface for the pee pad in the operational orientation and first alignment sections extending upward from the first planar base in the operational orientation. The system also includes a second section pivotably connected to the first section enabling the pet peed pad containment system to be pivoted between the operational orientation and the storage orientation. The second section includes a second planar base configuring for providing a support surface for the pee pad in the operational orientation and second alignment sections extending upward from the second planar base in the operational orientation. The first planar base and the second planar base area configured for supporting a bottom surface of the pee pad in the operational orientation. The first alignment sections and the second alignment sections are configured for defining, in the operational orientation, a receiving area for the pee pad and aligning the pee pad on the first planar base and the second planar base. The system also includes a seal configured for covering a seam between the first planar base and the second planar base in the operational orientation to prevent pee from leaking through the seam in the receiving area.

In examples, the seal is a strip extending along an entire length of the seam in the receiving area.

In examples, the seal is made of silicone.

In examples, the seal is fixed to both the first section and the second section.

In examples, the first alignment sections include: a first side wall section extending upward from the first planar base in the operational orientation; a second side wall section extending upward from the first planar base in the operational orientation; a first end wall extending upward from the first planar base in the operational orientation, the first end wall being between the first side wall section to the second side wall section; the second alignment sections include: a third side wall section extending upward from the second planar base in the operational orientation; a fourth side wall section extending upward from the second planar base in the operational orientation; a second end wall extending upward from the second planar base in the operational orientation, the second end wall being between the third side wall section to the fourth side wall section.

In examples, a first end of the first end wall is joined together with the first side wall section to form an L-shape corner for receiving a first corner of the pee pad; a second end of the first end wall is joined together with the second side wall section to form an L-shape corner for receiving a second corner of the pee pad; a first end of the second end wall is joined together with the third side wall section to form an L-shape corner for receiving a third corner of the pee pad; and a second end of the second end wall is joined together with the fourth side wall section to form an L-shape corner for receiving a fourth corner of the pee pad.

In examples, the first side wall section and the third side wall section are aligned with each other in a same first vertical plane in the operational orientation and contact each other in the storage orientation; wherein the second side wall section and the fourth side wall section are aligned with each other in a same second vertical plane in the operational orientation and contact each other in the storage orientation.

In examples, when viewed from above in the operational orientation, the first end wall defines a first side of a rectangle for receiving a pee pad, the first side wall section and the third side wall section together define a second side of the rectangle, the second end wall defines a third side of the rectangle, and the second side wall section and the fourth side wall section together define a fourth side of the rectangle, the first planar base and the second planar base being within the rectangle and being configured for supporting the pee pad in the operational orientation.

In examples, the first side wall section, the second side wall section, the first end wall, the third side wall section, the fourth side wall section and the second end wall form a walled perimeter for receiving the pee pad in the operation orientation.

In examples, the rectangle is 24.25 to 24.75 inches by 24.25 to 24.75 inches.

In examples, in the operational orientation, a top edge of the first end wall and a top edge of the second end wall face away from the floor, the top edge of the first end wall including at least one first connector, the top edge of the second end wall including at least one second connector, the at least one first connector configured for being connected to the at least one second connector in the storage orientation.

In examples, the first side wall section, the second side wall section, the first end wall, the third side wall section extend 0.75 to 2.5 inches from the first planar base and the fourth side wall section, and the second end wall each extend 0.75 to 2.5 inches from the second planar base.

In examples, an upper surface of the first planar base and an upper surface of the second planar base face away from the floor in the operational orientation, the upper surface of the first planar base and the upper surface of the second planar base face each other in the storage orientation.

In examples, a lower upper surface of the first planar base and/or a lower surface of the second planar base include at least one grip for frictional contact with the floor to prevent the pet peed pad containment system from sliding on the floor.

In examples, the first section includes a first handle section, the first planar base being inside of the first alignment sections and the first handle section being outside of the first alignment sections, the first handle section being spaced above the floor in the operational orientation; wherein the second section includes a second handle section, the second planar base being inside of the second alignment sections and the second handle section being outside of the second alignment sections, the second handle section being spaced above the floor in the operational orientation, the first handle section and the second handle section being configured for being joined together upon pivoting the first section and the second section into the storage orientation to form a handle for carrying the pet peed pad containment system in the storage orientation.

In examples, a system further including a detachable splash guard extending above the first alignment sections or the second alignment sections, the detachable splash guard being configured for being connected, in the operational orientation, to the first section or the second section to prevent pee for splashing out of the pet peed pad containment system in one direction.

In examples, the detachable splash guard extends at least six inches above the first planar based or the second planar base.

In examples, the first section includes at least one first connector and the second section includes at least one second connector, the at least one first connector configured for being connected to the at least one second connector in the storage orientation.

A pet peed pad containment system is also provided that is movable between an operational orientation and a storage orientation. The operational orientation enables use by a pet to pee on a pee pad held within the pet peed pad containment system. The system includes a first section including a first planar base configuring for providing a support surface for the pee pad in the operational orientation and first alignment sections extending upward from the first planar base in the operational orientation. The system also includes a second section pivotably connected to the first section enabling the pet peed pad containment system to be pivoted between the operational orientation and the storage orientation. The second section includes a second planar base configuring for providing a support surface for the pee pad in the operational orientation and second alignment sections extending upward from the second planar base in the operational orientation. The first planar base and the second planar base area configured for supporting a bottom surface of the pee pad in the operational orientation. The first alignment sections and the second alignment sections are configured for defining, in the operational orientation, a receiving area for the pee pad and aligning the pee pad on the first planar base and the second planar base. The system also includes a first handle section on the first section, the first planar base being inside of the first alignment sections and the first handle section being outside of the first alignment sections, the first handle section being spaced above the floor in the operational orientation; and a second handle section on the second section, the second planar base being inside of the second alignment sections and the second handle section being outside of the second alignment sections, the second handle section being spaced above the floor in the operational orientation, the first handle section and the second handle section being configured for being joined together upon pivoting the first section and the second section into the storage orientation to form a handle for carrying the pet peed pad containment system in the storage orientation.

A pet peed pad containment system is also provided that is movable between an operational orientation and a storage orientation. The operational orientation enables use by a pet to pee on a pee pad held within the pet peed pad containment system. The system includes a first section including a first planar base configuring for providing a support surface for the pee pad in the operational orientation and first alignment sections extending upward from the first planar base in the operational orientation. The system also includes a second section pivotably connected to the first section enabling the pet peed pad containment system to be pivoted between the operational orientation and the storage orientation. The second section includes a second planar base configuring for providing a support surface for the pee pad in the operational orientation and second alignment sections extending upward from the second planar base in the operational orientation. The first planar base and the second planar base area configured for supporting a bottom surface of the pee pad in the operational orientation. The first alignment sections and the second alignment sections are configured for defining, in the operational orientation, a receiving area for the pee pad and aligning the pee pad on the first planar base and the second planar base. The system also includes a detachable splash guard extending above the first alignment sections or the second alignment sections, the detachable splash guard being configured for being connected, in the operational orientation, to the first section or the second section to prevent pee for splashing out of the pet peed pad containment system in one direction.

### BRIEF SUMMARY OF THE DRAWINGS

FIG. 1a shows an embodiment of a pet peed pad containment system in the operational orientation receiving a pee pad;

FIG. 1b shows the pet peed pad containment system in the operational orientation without a pee pad;

FIG. 2a shows a perspective view of the pet peed pad containment system in the storage orientation;

FIG. 2b shows a side view of the pet peed pad containment system in the storage orientation;

FIG. 3a illustrates the pet peed pad containment system in the operational orientation receiving a pee pad and with a detachable splash guard; and

FIG. 3b shows the pet peed pad containment system in the operational orientation without a pee pad and with a detachable splash guard.

### DETAILED DESCRIPTION

The present disclosure provides an embodiment of a pet peed pad containment system 10 that is movable between an operational orientation and a storage orientation. The operational orientation enables use by a pet to pee on a pee pad 12 held within the pet peed pad containment system 10. The pet peed pad containment system 10 is a collapsible, travel-friendly pee pad holder designed to provide a secure, leak-resistant surface for dogs to relieve themselves. The system is optimized for portability, durability, and ease of use and can prevent leakage, pad shifting, and lack of containment. Its hinged, foldable design and integrated carrying handle allow pet peed pad containment system 10 to be easily transported and stored, making pet peed pad containment system 10 ideal for pet owners with active lifestyles or limited space.

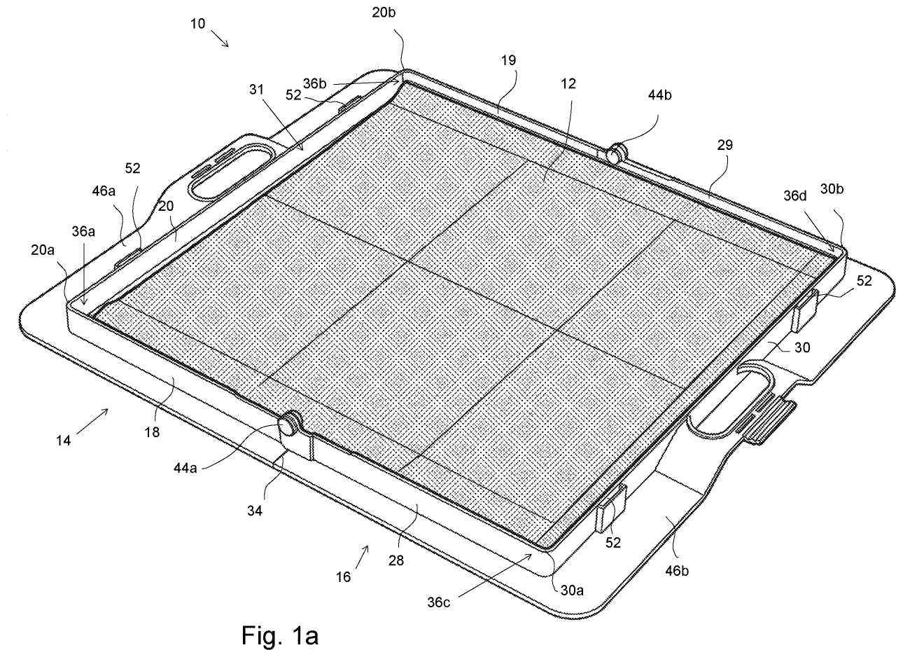

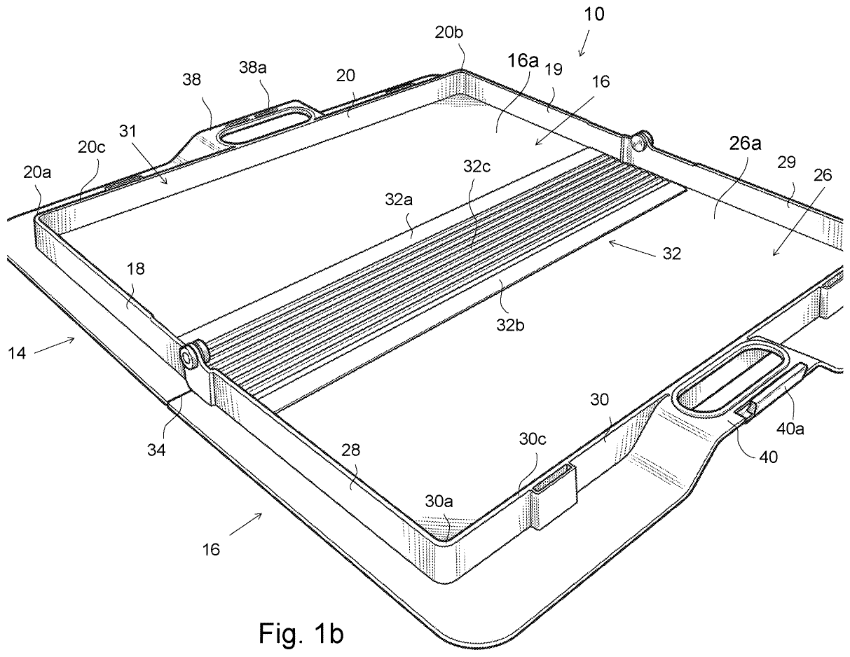

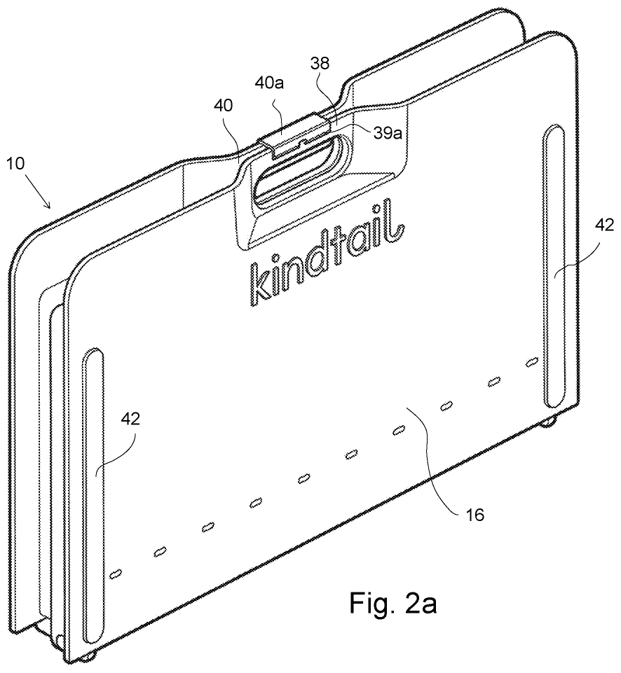

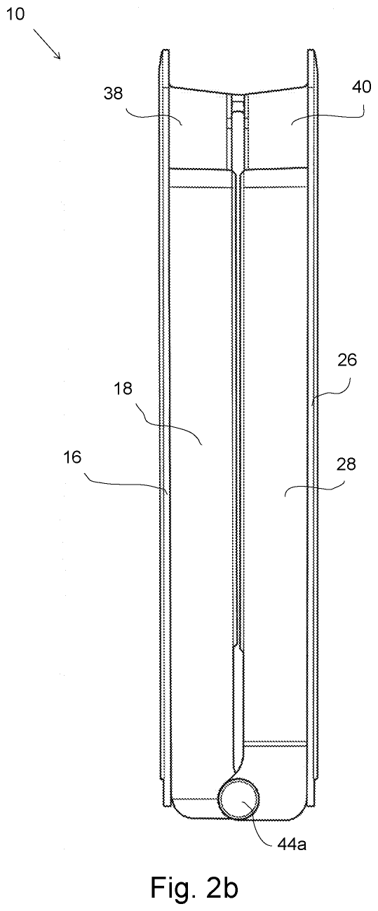

FIG. 1a shows pet peed pad containment system 10 in the operational orientation receiving a pee pad 12 and FIG. 1b shows pet peed pad containment system 10 in the operational orientation without a pee pad. FIG. 2a shows a perspective view of pet peed pad containment system 10 in the storage orientation and FIG. 2b shows a side view of pet peed pad containment system 10 in the storage orientation.

The pet peed pad containment system 10 includes a first section 14 includes a first planar base 16 configured for resting on a floor in the operational orientation and first alignment sections, which in the illustrated embodiment are a first side wall section 18, a second side wall section 19, and a first end wall 20, that extend upward from the first planar base 16 in the operational orientation.

A second section 24 is pivotably connected to the first section 14 in a manner that enables the pet peed pad containment system 10 to be pivoted between the operational orientation and the storage orientation. The second section 24 includes a second planar base 26 configured for resting on the floor 24 in the operational orientation and first alignment sections, which in the illustrated embodiment are a third side wall section 28, a fourth side wall section 29, and a second end wall 30, that extend upward from the second planar base 26 in the operational orientation.

Each of first section 14 and second section 24 can be formed of plastic. In one example, the plastic can be polypropylene.

The first planar base 16 and the second planar base 26 are configured for supporting a bottom surface of the pee pad 12 in the operational orientation. The first alignment sections and the second alignment sections are configured for aligning the pee pad 12 on the first planar base 16 and the second planar base 26 in the operational orientation and define a receiving area 31 for the pee pad 12 within the pet peed pad containment system 10 on the first planar base 16 and second planar base 26.

A seal 32 is configured for covering a seam 34 between the first planar base 16 and the second planar base 26 in the receiving area 31 in the operational orientation. The seal 32 prevents pee from leaking through the seam 34, which is a gap that is formed between the first planar base 16 and the second planar base 26 in the operational orientation.

In the illustrated embodiment, the seal 32 is a strip extending along an entire length of the seam 34 within the receiving area 31. In other words, the seal 32 cover the portion of the seam 34 that is between a first side wall formed by first wall section 18 and third side wall section 28 and a second side wall formed by second side wall section 19 and fourth side wall section 29 to prevent pee from leaking between first planar base 16 and second planar base 26 in the receiving area 31 in the operational orientation. The seal 32 can for example be 4 to 7 inches wide and 23.5 to 24.5 inches long.

The seal 32 is fixed to both the first section 14 and the second section 24 such that is does not come disconnected from the first planar base 16 and second planar base 26 when the pet peed pad containment system 10 is pivoted between the storage orientation and the operation orientation. In one advantage example, the seal 32 can be made of silicone. In other examples, the seal 32 can be made of another polymer including a plastic or rubber. Seal 32 includes a first longitudinally extending edge section 32a that is fixed to first planar base 16, a second longitudinally extending edge section 32b that is fixed to second planar base 26 and a longitudinally extending interior section 32c for covering the seam 34 that is laterally between first edge section 32a and second edge section 32b.

In the operational orientation, the first side wall section 18 extends upward from the first planar base 16 in the operational orientation, the second side wall section 19 extends upward from the first planar base 16 in the operational orientation and the first end wall 20 extends upward from the first planar base 16. The first end wall 20 is between the first side wall section 18 and the second side wall section 19. The first planar base 16 is inside of the first side wall section 18, second side wall section 19 and first end wall 20.

In the operational orientation, the third side wall section 28 extends upward from the second planar base 26 in the operational orientation, the fourth side wall section 29 extends upward from the second planar base 26 in the operational orientation and the second end wall 30 extends upward from the second planar base 26. The second end wall 30 is between the third side wall section 28 and the fourth side wall section 29. The second planar base 26 is inside of the third side wall section 28, fourth side wall section 29 and second end wall 30.

A first end 20a of the first end wall 20 is joined together with the first side wall section 18 to form a first L-shape corner 36a for receiving and aligning a first corner of the pee pad 12. A second end 20b of the first end wall 20 is joined together with the second side wall section 19 to form a second L-shape corner 36b for receiving and aligning a second corner of the pee pad 12.

A first end 30a of the second end wall 30 is joined together with the third side wall section 28 to form a third L-shape corner 36c for receiving and aligning a third corner of the pee pad 12. A second end 30b of the second end wall 30 is joined together with the fourth side wall section 29 to form a fourth L-shape corner 36d for receiving and aligning a fourth corner of the pee pad 12.

The first side wall section 18 and the third side wall section 28 are aligned with each other in a same first vertical in the operational orientation. The second side wall section 19 and the fourth side wall section 29 are aligned with each other in a same second vertical plane in the operational orientation.

The first side wall section 18 and the third side wall section 28 contact each other in the storage orientation. The second side wall section 19 and the fourth side wall section 29 contact each other in the storage orientation.

When viewed from above in the operational orientation, the first side wall section 18, second side wall section 19 and first end wall 20 together define a first half of the rectangle and third side wall section 28, fourth side wall section 29 and second end wall 30d define a second half of the rectangle. From this view, the first end wall 20 defines a first side of a rectangle for receiving a pee pad 12. The first side wall section 18 and the third side wall section 28 together define a second side of the rectangle. The second end wall 30 defines a third side of the rectangle. The second side wall section 19 and the fourth side wall section 29 together define a fourth side of the rectangle. The first planar base 16 and the second planar base 26 are within the rectangle. In the operational orientation, the first side wall section 18, second side wall section 19, first end wall 20, third side wall section 28, fourth side wall section 29, and second end wall 30 together form a perimeter wall defining a volume having a rectangular cross-section that is delimited at the bottom by first planar base 16 and second planar base 26 and open at the top. In one advantageous example, the rectangle is 24.25 to 24.75 inches by 24.25 to 24.75 inches. In particular, the rectangle is advantageously a square.

The first side wall section 18, second side wall section 19, first end wall 20, third side wall section 28, fourth side wall section 29 and second end wall 30 can each have a height of 0.75 to 1.75 inches such that the volume having the rectangular cross-section for receiving the pee pad 12 has a height of 0.75 to 2.5 inches. In other words, the first side wall section 18, the second side wall section 19, the first end wall 20, and the third side wall section 28 extend 0.75 to 2.5 inches from the first planar base 16. The fourth side wall section 29 and the second end wall 30 each extend 0.75 to 2.5 inches from the second planar base 26. In particular, the height can be 1.0 to 1.5 inches.

The pet peed pad containment system 10 further includes a handle formed on both of first section 14 and second section 24. In particular, the handle is formed by a first handle section 38 formed integrally as a single piece with first end wall 20 and a second handle section 10 formed integrally as a single piece with second end wall 30. The first handle section 38 is outside of the first end wall 20. The first handle section 38 is spaced above the floor 24 in the operational orientation.

The second section 24 includes a second handle section 40. The second handle section 40 is outside of the second end wall 30. The second handle section 40 is spaced above the floor 24 in the operational orientation. The first handle section 38 and the second handle section 40 are configured for being joined together upon pivoting the first section 14 and the second section 24 into the storage orientation. The first handle section 38 and the second handle section 40 form a handle for carrying the pet peed pad containment system 10 in the storage orientation.

The first handle section 38 includes a first connector 38a and the second handle section 40 includes a second connector 40a that can be joined together to fix the pet peed pad containment system 10 in the storage orientation. In illustrated embodiment, the first connector 38a includes at least one slot and the second connector 40a includes at least one projection for being inserted into the at least one slot.

The first handle section 38 includes a first hole 38b configured for receiving a portion of user's hand and the second handle section 40 includes a second hole 40b configured for receiving a portion of a user's hand such that a user can grip handle sections 38, 40 together by passing part of the user's hand through the holes 38b, 40b together.

An upper surface 16a of the first planar base 16 and an upper surface 26a of the second planar base 26 face away from the floor 24 in the operational orientation. The upper surface 16a of the first planar base 16 and the upper surface 26a of the second planar base 26 face each other in the storage orientation.

As illustrated in FIG. 2a, a lower surface of the first planar base 16 include grips 42 for frictional contact with the floor 24. Grips 42 can be formed as silicon strips extending on opposite sides of first planar base 16. A lower surface of the second planar base 26 can also include at least grip configured in the same manner as grips 42. The grips 42 prevents the pet peed pad containment system 10 from sliding on the floor.

The first section 14 and the second section 24 are hinged together by a first pin 44a passing through first side wall section 18 and third side wall section 28 to pivotably connect first side wall section 18 and third side wall section 28 together and a second pin 44b passing through second side wall section 19 and fourth side wall section 29 to pivotably connect second side wall section 19 and fourth side wall section 29 together. To pivot from the operational orientation to the storage orientation, the user can grip one or both of the handle sections 38, 40 and force handle section 38 and/or 40 handle section 40 toward the other, which causes first end wall 20 and second end wall 30 to come closer together and contact each other, and also causing first L-shape corner 36a to contact third L-shape corner 36c and causing second L-shape corner 36b to contact fourth L-shape corner 36d.

A first border 46a contiguous with first planar base 16 extends outward past first side wall section 18, second side wall section 19 and first end wall 20 to provide further structural support for first section 14. A second border 46b contiguous with second planar base 26 extends outward past third side wall section 28, fourth side wall section 29 and second end wall 30 to provide further structural support for second section 24. Outside of first end wall 20, the first border 46a merges with first handle section 38 and outside second end wall 30, the second border 46b merges with second handle section 40.

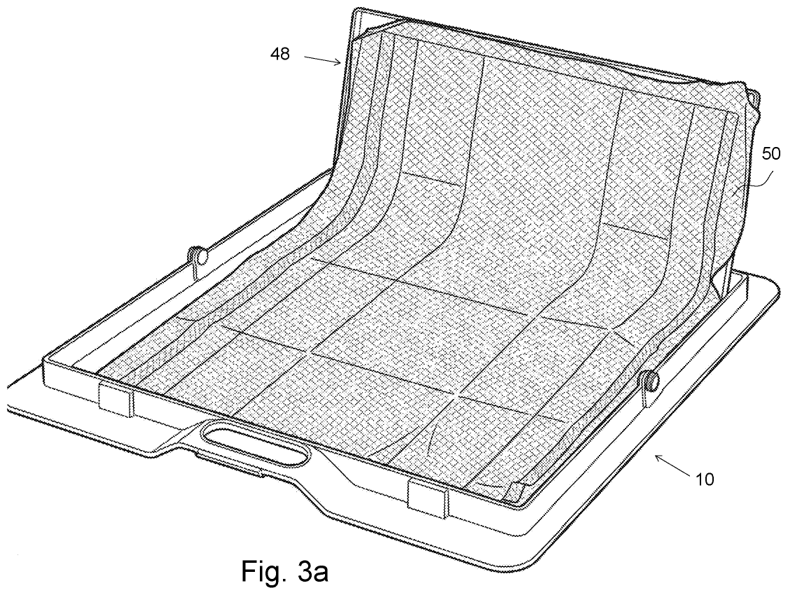

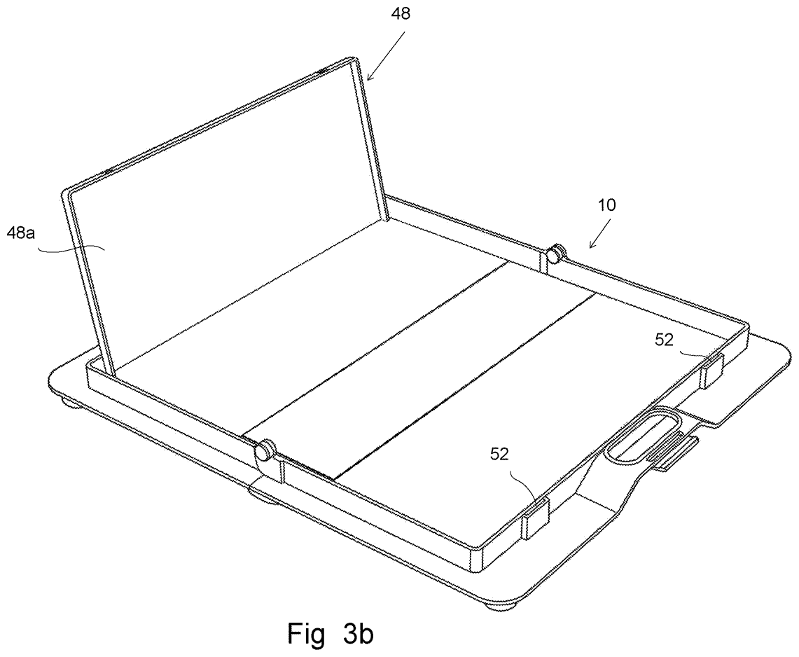

FIG. 3a illustrates pet peed pad containment system 10 in the operational orientation receiving a pee pad 12 and with a detachable splash guard 48 and FIG. 3b shows pet peed pad containment system 10 in the operational orientation without a pee pad and with a detachable splash guard 48.

The detachable splash guard 48 includes a base plate 48a that extends vertically upward along one of the sides of the walled perimeter to provide a vertically extending surface to block a male dog's pee. As illustrated in FIG. 3a, a longer pee pad 50 can be used in place of pee pad 12 to cover the base plate 48a. The detachable splash guard 48 can extend at least six inches above the first planar base 16 or the second planar base 26. The detachable splash guard 48 extends above the walled perimeter. The detachable splash guard 48 is configured for being connected, in the operational orientation, to the first section 14 or the second section 24. The detachable splash guard 48 prevents pee from splashing out of the pet peed pad containment system 10 in one direction.

The base plate 48a has a rectangular shape and can be 6 to 12 inches in height and 20 inches to 24.5 includes wide. Detachable splash guard 48 can include tabs that extend downward from base plate 48a that are shaped for insertion into slots 52 formed on the walled perimeter. In the illustrated embodiment, the slots 52 are in both first end wall 20 and second end wall 30.

In the preceding specification, the present disclosure has been described with reference to specific exemplary embodiments and examples thereof. It will, however, be evident that various modifications and changes may be made thereto without departing from the broader spirit and scope of present disclosure as set forth in the claims that follow. The specification and drawings are accordingly to be regarded in an illustrative manner rather than a restrictive sense.

What is claimed is:

1. A pet peed pad containment system movable between an operational orientation and a storage orientation, the operational orientation enabling use by a pet to pee on a pee pad held within the pet peed pad containment system, the system comprising:
a first section including:
a first planar base configuring for providing a support surface for the pee pad in the operational orientation;
first alignment sections extending upward from the first planar base in the operational orientation; and
a second section pivotably connected to the first section enabling the pet peed pad containment system to be pivoted between the operational orientation and the storage orientation, the second section including:
a second planar base configuring for providing a support surface for the pee pad in the operational orientation; and
second alignment sections extending upward from the second planar base in the operational orientation;
the first planar base and the second planar base being configured for supporting a bottom surface of the pee pad in the operational orientation, the first alignment sections and the second alignment sections configured for defining, in the operational orientation, a receiving area for the pee pad and aligning the pee pad on the first planar base and the second planar base;
a seal configured for covering a seam between the first planar base and the second planar base in the operational orientation to prevent pee from leaking through the seam in the receiving area.

2. The system as recited in claim 1 wherein the seal is a strip extending along an entire length of the seam in the receiving area.

3. The system as recited in claim 1 wherein the seal is made of silicone.

4. The system as recited in claim 1 wherein the seal is fixed to both the first section and the second section.

5. The system as recited in claim 1 wherein:
the first alignment sections include:
a first side wall section extending upward from the first planar base in the operational orientation;
a second side wall section extending upward from the first planar base in the operational orientation;
a first end wall extending upward from the first planar base in the operational orientation, the first end wall being between the first side wall section to the second side wall section;
the second alignment sections include:
a third side wall section extending upward from the second planar base in the operational orientation;
a fourth side wall section extending upward from the second planar base in the operational orientation;
a second end wall extending upward from the second planar base in the operational orientation, the second end wall being between the third side wall section to the fourth side wall section.

6. The system as recited in claim 5 wherein:
a first end of the first end wall is joined together with the first side wall section to form an L-shape corner for receiving a first corner of the pee pad;
a second end of the first end wall is joined together with the second side wall section to form an L-shape corner for receiving a second corner of the pee pad;
a first end of the second end wall is joined together with the third side wall section to form an L-shape corner for receiving a third corner of the pee pad; and
a second end of the second end wall is joined together with the fourth side wall section to form an L-shape corner for receiving a fourth corner of the pee pad.

7. The system as recited in claim 5 wherein the first side wall section and the third side wall section are aligned with each other in a same first vertical plane in the operational orientation and contact each other in the storage orientation;
wherein the second side wall section and the fourth side wall section are aligned with each other in a same second vertical plane in the operational orientation and contact each other in the storage orientation.

8. The system as recited in claim 5 wherein, when viewed from above in the operational orientation, the first end wall defines a first side of a rectangle for receiving a pee pad, the first side wall section and the third side wall section together define a second side of the rectangle, the second end wall defines a third side of the rectangle, and the second side wall section and the fourth side wall section together define a fourth side of the rectangle,
the first planar base and the second planar base being within the rectangle and being configured for supporting the pee pad in the operational orientation.

9. The system as recited in claim 8 wherein the first side wall section, the second side wall section, the first end wall, the third side wall section, the fourth side wall section and the second end wall form a walled perimeter for receiving the pee pad in the operation orientation.

10. The system as recited in claim 8 wherein the rectangle is 24.25 to 24.75 inches by 24.25 to 24.75 inches.

11. The system as recited in claim 5 wherein, in the operational orientation, a top edge of the first end wall and a top edge of the second end wall face away from the floor,
the top edge of the first end wall including at least one first connector,
the top edge of the second end wall including at least one second connector,
the at least one first connector configured for being connected to the at least one second connector in the storage orientation.

12. The system as recited in claim 5 wherein the first side wall section, the second side wall section, the first end wall, the third side wall section extend 0.75 to 2.5 inches from the first planar base and the fourth side wall section, and the second end wall each extend 0.75 to 2.5 inches from the second planar base.

13. The system as recited in claim 1 wherein an upper surface of the first planar base and an upper surface of the second planar base face away from the floor in the operational orientation,
the upper surface of the first planar base and the upper surface of the second planar base face each other in the storage orientation.

14. The system as recited in claim 13 wherein a lower upper surface of the first planar base and/or a lower surface of the second planar base include at least one grip for frictional contact with the floor to prevent the pet peed pad containment system from sliding on the floor.

15. The system as recited in claim 1 wherein the first section includes a first handle section, the first planar base being inside of the first alignment sections and the first handle section being outside of the first alignment sections, the first handle section being spaced above the floor in the operational orientation;
wherein the second section includes a second handle section, the second planar base being inside of the second alignment sections and the second handle section being outside of the second alignment sections, the second handle section being spaced above the floor in the operational orientation,
the first handle section and the second handle section being configured for being joined together upon pivoting the first section and the second section into the storage orientation to form a handle for carrying the pet peed pad containment system in the storage orientation.

16. The system as recited in claim 1 further comprising a detachable splash guard extending above the first alignment sections or the second alignment sections, the detachable splash guard being configured for being connected, in the operational orientation, to the first section or the second section to prevent pee for splashing out of the pet peed pad containment system in one direction.

17. The system as recited in claim 16 wherein the detachable splash guard extends at least six inches above the first planar based or the second planar base.

18. The system as recited in claim 13 wherein the first section includes at least one first connector and the second section includes at least one second connector,
the at least one first connector configured for being connected to the at least one second connector in the storage orientation.

19. A pet peed pad containment system movable between an operational orientation and a storage orientation, the operational orientation enabling use by a pet to pee on a pee pad held within the pet peed pad containment system, the system comprising:
a first section including:
a first planar base configuring for providing a support surface for the pee pad in the operational orientation; and
first alignment sections extending upward from the first planar base in the operational orientation; and
a second section pivotably connected to the first section enabling the pet peed pad containment system to be pivoted between the operational orientation and the storage orientation, the second section including:
a second planar base configuring for providing a support surface for the pee pad in the operational orientation; and
second alignment sections extending upward from the second planar base in the operational orientation;
the first planar base and the second planar base being configured for supporting bottom surface of the pee pad in the operational orientation, the first alignment sections and the second alignment sections configured for aligning the pee pad on the first planar base and the second planar base in the operational orientation;
a first handle section on the first section, the first planar base being inside of the first alignment sections and the first handle section being outside of the first alignment sections, the first handle section being spaced above the floor in the operational orientation;
a second handle section on the second section, the second planar base being inside of the second alignment sections and the second handle section being outside of the second alignment sections, the second handle section being spaced above the floor in the operational orientation,
the first handle section and the second handle section being configured for being joined together upon pivoting the first section and the second section into the storage orientation to form a handle for carrying the pet peed pad containment system in the storage orientation.

20. A pet peed pad containment system movable between an operational orientation and a storage orientation, the operational orientation enabling use by a pet to pee on a pee pad held within the pet peed pad containment system, the system comprising:
a first section including:
a first planar base configuring for providing a support surface for the pee pad in the operational orientation; and
first alignment sections extending upward from the first planar base in the operational orientation;
a second section pivotably connected to the first section enabling the pet peed pad containment system to be pivoted between the operational orientation and the storage orientation, the second section including:
a second planar base configuring for providing a support surface for the pee pad in the operational orientation; and
second alignment sections extending upward from the second planar base in the operational orientation
the first planar base and the second planar base being configured for supporting a bottom surface of the pee pad in the operational orientation, the first alignment sections and the second alignment sections configured for aligning the pee pad on the first planar base and the second planar base in the operational orientation; and
a detachable splash guard extending above the first alignment sections or the second alignment sections, the detachable splash guard being configured for being connected, in the operational orientation, to the first section or the second section to prevent pee for splashing out of the pet peed pad containment system in one direction.
